(19) United States
(12) Patent Application Publication
(10) Pub. No.: US 2016/0178107 A1
(43) Pub. Date: Jun. 23, 2016

(54) SEALANT HOSE AND METHOD OF USE

(71) Applicants: Robert CACCIABEVE, Boonton, NJ (US); Anthony QUINN, Jonesborough, TN (US); Randy PRICE, Pekin, IL (US)

(72) Inventors: Robert CACCIABEVE, Boonton, NJ (US); Anthony QUINN, Jonesborough, TN (US); Randy PRICE, Pekin, IL (US)

(21) Appl. No.: 14/975,268

(22) Filed: Dec. 18, 2015

Related U.S. Application Data
(60) Provisional application No. 62/094,979, filed on Dec. 20, 2014.

(51) Int. Cl. F16L 55/164; F16L 11/00

(52) U.S. Cl. CPC F16L 55/164; F16L 11/00

(57) ABSTRACT

A sealant hose having retained therein a sealant or other fluid material for insertion into a closed system such as an air conditioner or refrigeration system. The hose includes at one end thereof an inlet valve and at the other end thereof an outlet valve. The inlet valve and the outlet valve may be connected to the hose by use of a collar or other securing member. The inlet valve comprises a needle valve for attachment a manifold gauge. The outlet valve is adapted to attach to an air conditioner or refrigeration service port.

### RELATED APPLICATION

This application claims benefit of U.S. Provisional Application Ser. No. 62/094,979, filed Dec. 20, 2014, entitled “Sealant Hose And Method Of Use,” and incorporated herein by reference in its entirety.

### FIELD OF THE INVENTION

The present invention relates to a sealant hose and method of use. More particularly, the invention relates to a sealant hose for providing a sealant or other fluid material to air conditioner and refrigeration systems.

### BACKGROUND OF THE INVENTION

Air conditioning systems, for the home, commercial, industrial and automotive, and refrigeration systems include means such as coils or the like through which a refrigerant runs. The invention is useful in such systems for dispensing a sealant or other fluid (liquid or gas) material. The invention will be explained with respect to residential air conditioning systems and dispensing of a sealant, although it is understood that the invention may be useful in other such systems.

Residential air conditioner (sometimes referred to as “A/C”) systems include coils through which a refrigerant runs. At times, the coils may deteriorate and provide an opening through which the refrigerant leaks or through which moisture may enter the coil and contaminate the refrigerant. When this happens, it is necessary to replace the coil, fix the component or provide a sealant to the A/C system to seal the leak.

Sealants are known in the art for sealing a leak in an A/C system. For example, there is known in the art a product entitled “Super Seal HVAC Leak Kit” which includes a can of sealant, which is connected to a hose. The hose is then connected to an air conditioner service port. The end connected to the can of sealant includes a valve which is opened and with the A/C system running, the sealant in the can enters through the hose and through the A/C system and is said to seal most leaks in the A/C system.

It is also known in the art to use a syringe which is attached to a service port, and the sealant is inserted into the A/C system.

While the prior art sealants have been useful up to a point, there is a need in the art for an improved apparatus and method for providing sealants to air conditioner and refrigeration systems.

### SUMMARY OF THE INVENTION

A primary object of the present invention is to provide a new sealant hose which will provide a sealant to an air conditioning or refrigeration system.

Another primary object of the present invention is to provide a hose which will provide other materials to air conditioning or refrigeration systems.

The sealant hose of the present invention comprises a hose having retained therein a sealant or other fluid material for insertion into a closed system such as an air conditioner or refrigeration system. The hose includes at one end thereof an inlet valve and at the other end thereof an outlet valve. The inlet valve and the outlet valve may be connected to the hose by use of a collar or other securing member. The inlet valve comprises a needle valve for attachment to an air conditioner or refrigeration manifold gauge. The outlet valve is adapted to attach to an air conditioner or refrigeration system service port.

The present invention further comprises the method of using the sealant hose. In one preferred method, the inlet valve of the sealant hose is attached to a manifold gauge and the outlet valve is attached to a service port of the air conditioner or refrigeration system. After attaching the sealant hose, the manifold gauge is opened providing pressure which moves the sealant fluid through the outlet valve and into the air conditioner or refrigeration system. The sealant will thereafter seal most leaks in the condenser coil, evaporator coil, all tubing or service ports of the air conditioner or refrigeration system.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a perspective view of the sealant hose of the present invention attached to an A/C manifold gauge and to an air conditioner system.

FIG. 2 is an exploded view of the sealant hose of the present invention.

FIG. 3 is a cross-section of the inlet valve of the sealant hose taken along line 3-3 of FIG. 2.

FIG. 4 is a cross-section of the outlet valve of the sealant hose taken along line 4-4 of FIG. 2.

### DETAILED DESCRIPTION OF THE PREFERRED EMBODIMENTS

Referring to the drawings, there is disclosed a sealant hose for providing a sealant or other material to a closed system such as a residential air conditioning system. The invention will be described in relation to providing a sealant to a residential air conditioning system. However, it is understood that the sealant hose may provide other fluid materials to other air conditioner systems, refrigeration systems or other closed loop systems.

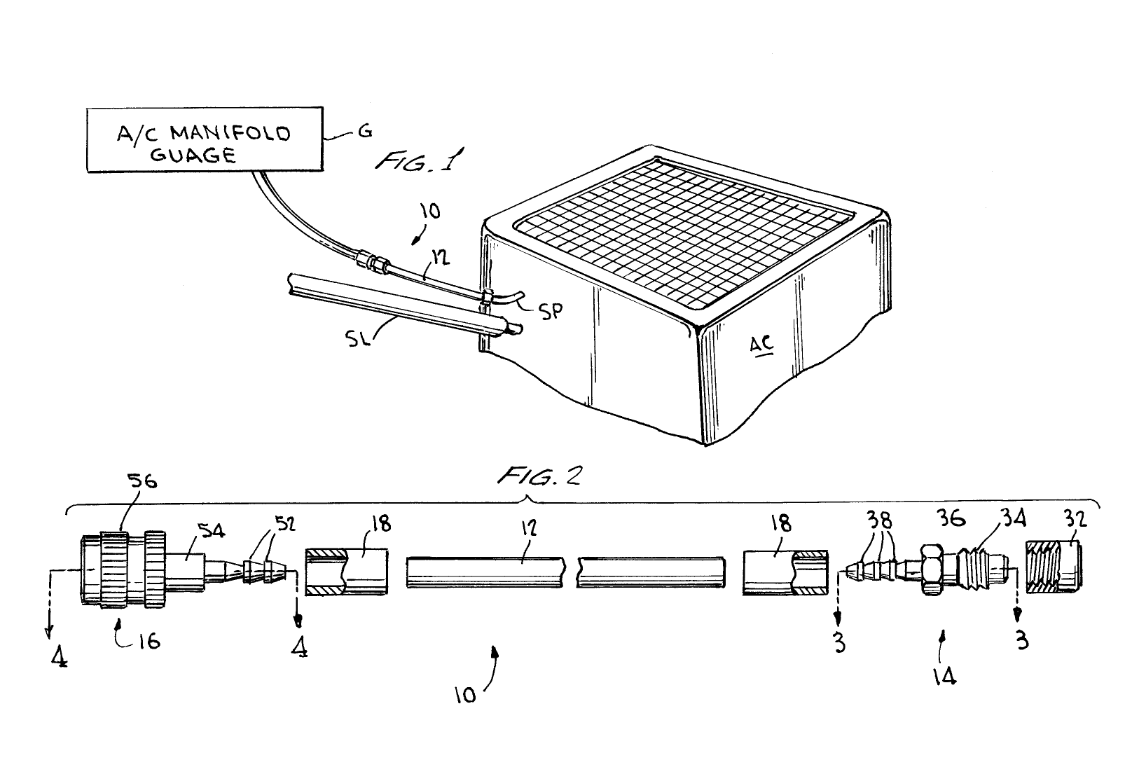

Referring to FIG. 1, there is disclosed the sealant hose 10 of the present invention attached to a service port SP of an air conditioning system AC. The sealant hose is connected to an air conditioning manifold gauge G. Also shown in FIG. 1, there is an insulated suction line SL of the air conditioning system. Referring to FIGS. 1 and 2, the sealant hose comprises a hose 12 preferably made of plastic such as polyethylene, polypropylene or polyvinyl chloride. The hose 12 includes an inlet valve 14 and an outlet valve 16. The valves 14 and 16 are secured to the hose by collars 18, preferably made of aluminum or brass. There is contained in the hose a fluid material (not shown) such as a sealant for an air conditioning system.

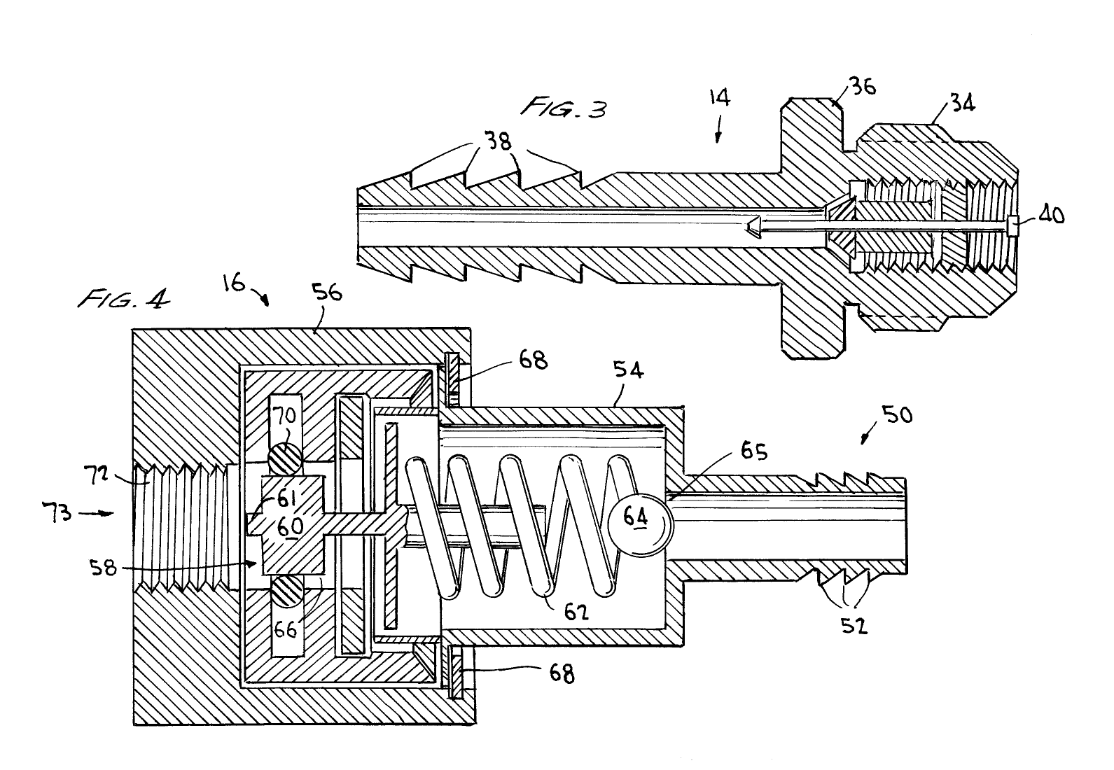

Referring to FIGS. 2 and 3, the sealant hose of the invention includes an inlet valve 14. The inlet valve 14 may be a needle valve. The valve 14 includes a threaded end for attaching a cap 32 to the device, preferably made of a plastic material. The cap 32 is removed when the device is in use and the threads 34 may be used to attach the sealant hose to the manifold gauge G. The inlet valve 14 further includes a nut portion 36 which may be gripped with a wrench, if necessary. The inlet hose further includes ribs 38 which are used to attach the inlet valve 14 to the inside of the hose 12. The ribs will engage the interior of the hose 12. As seen above, the collar 18 is further used to make sure the inlet valve is secured to the hose. The collar 18 surrounds the outside of the hose and after attachment is pinched such that the collar tightly secures the hose to the inlet valve 14. The inlet valve 14 further includes a plunger 40 which when attached to the manifold gauge G will push down providing an opening for receiving pressure from the manifold gauge G.

Referring to FIGS. 2 and 4, there is disclosed the outlet valve 16. The outlet valve 16 generally comprises an end portion 50 having ribs 52 for connecting the outlet valve to the tube 12 similar to the inlet valve as previously described. The outlet valve once attached to tube 12 is further secured by outer collar 18 as described above for the inlet valve. The outlet valve 16 is constructed and arranged such that the fluid sealant in tube 12 will not leak from the sealant hose when in transport and not in use. When the valve 16 is attached to a service port of an air conditioning system or other system, the valve will open (as discussed hereafter) thereby allowing the fluid sealant or other material to release to the air conditioning system or other closed loop system.

The outlet valve 16 further comprises a first housing 54 connected to a second housing 56. Within these housings there is a valve comprising a plunger 58, a closing member 60, a spring 62 and a ball 64 for opening and closing the system at opening 66. The outer housing 56 is attached to the inner housing 54 by means of a C-ring 68. The valve further includes an O-ring 70 for sealing the valve at closing member 60. The outer housing 56 includes internal threads 72 for connecting the outlet valve to the service port of an air conditioning system or other system.

In operation, the outlet valve works as follows: when the sealant hose is not attached to the air conditioning system, the valve is closed allowing for no leakage of the fluid sealant. The valve is closed at opening 66 by closing member 60 at opening 66. The O-ring 70 serves to seal the closure. Spring 62 is in an uncompressed state to close the valve 60. Also, ball 64 will seat in opening 65 to close the passage way. When the outlet valve 16 is attached to the service port SP of the air conditioning system as shown in FIG. 1, the outlet valve is opened by a tapered member (not shown) of the service port entering the opening 73 of valve 16 and engages closing member 60 at 61 to push member 60 inward and opening passageway 66, which compresses spring 62. As discussed below, when the gauge is opened the pressure will move ball 64 out of passageway 65. An additional feature of the invention is that ball 64 provides a blow back feature to prevent fluid from returning from the system through passageway 65 into gauge G.

The sealant hose may include a fluid material (liquid or gas) which in the preferred embodiment is a liquid sealant used to seal leaks in an air conditioning system. A presently preferred sealant is made by Nu-Calgon and sold under the brand name EASYSEAL. Other materials may be used in the system such as oil, dye material used to detect leaks, drying agents or the like.

In operation, the sealant hose 12 is attached to a manifold gauge G and to a service port SP of the air conditioning system. The manifold gauge is opened providing pressure to the inlet valve, which moves the fluid sealant through the open outlet valve 16 into the air conditioning system. The sealant passes through the air conditioning system and will seal most leaks throughout the system. As discussed above, if pressure from the system were to “blow back,” ball 64 will close passageway 65 to prevent fluid from going back into the tube and into the gauge G.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A sealant hose for an air conditioning or refrigeration system comprising a hose containing a fluid sealant adapted to seal a leak in the system, an inlet valve at one end of said hose comprising a needle valve and adapted to engage a manifold gauge, and an outlet valve at an opposite end of said hose adapted to engage a service port of said system, said outlet valve further comprising means to maintain said fluid sealant in said sealant hose when not in use.

2. A sealant hose according to claim 1 wherein said means to maintain said fluid sealant in said sealant hose when not in use comprises a first housing adapted to be connected to said hose and a second housing having an opening adapted to be connected to said service port, and within said first and second housings an opening adapted to release said fluid sealant, said release of said fluid sealant being controlled by a valve, a closing member, a spring and a ball.

3. A method of sealing a leak in an air conditioning or refrigeration system with a sealant hose comprising the steps of (a) attaching one end of said sealant hose to manifold gauge; (b) attaching an opposite end of said sealant hose to a service port of said air conditioning or refrigeration system; and (c) releasing a fluid sealant from said sealant hose to said air conditioning or refrigeration system to seal a leak in said system, wherein said sealant hose comprises a hose containing said fluid sealant, an inlet valve at one end of said hose comprising a needle valve and adapted to engage a manifold gauge, and an outlet valve at an opposite end of said hose adapted to engage a service port of said system, said outlet valve further comprising means to maintain said fluid sealant in said sealant hose when not in use.

4. A method according to claim 3 wherein said means to maintain said fluid sealant in said sealant hose when not in use comprises a first housing adapted to be connected to said hose and a second housing having an opening adapted to be connected to said service port, and within said first and second housings an opening adapted to release said fluid sealant, said release of said fluid sealant being controlled by a valve, a closing member, a spring and a ball.
